(19) United States
(12) Patent Application Publication
(10) Pub. No.: US 2026/0132324 A1
(43) Pub. Date: May 14, 2026

(54) COMPOSITIONS CONTAINING PHASE CHANGE MATERIALS, METHODS FOR FORMING OBJECTS USING THE SAME, AND METHOD FOR USING THE SAME

(71) Applicant: PHASE CHANGE ENERGY SOLUTIONS, INC., Greensboro, NC (US)

(72) Inventors: Reyad I. SAWAFTA, Greensboro, NC (US); Venu Gopal R. KUTURU, Greensboro, NC (US); Brian Steven CHAPMAN, Greensboro, NC (US); John A. GERIG, Greensboro, NC (US); Anne MCLEAN, Greensboro, NC (US)

(73) Assignee: PHASE CHANGE ENERGY SOLUTIONS, INC., Greensboro, NC (US)

(21) Appl. No.: 19/118,710

(22) PCT Filed: Oct. 11, 2023
(86) PCT No.: PCT/US2023/076543

§ 371 Date: Apr. 4, 2025

Related U.S. Application Data
(60) Provisional application No. 63/415,106, filed on Oct. 11, 2022.

(51) Int. Cl. C09K 5/06; B29C 48/00; B29K 105/00; B65D 81/18; C08K 3/38; C08K 5/05; C08K 5/053; C08K 5/09; C08K 5/092; C08K 5/101

(52) U.S. Cl. CPC C09K 5/066; B65D 81/18; C08K 3/38; C08K 5/05; C08K 5/053; C08K 5/09; C08K 5/092; C08K 5/101; C09K 5/063; B29C 48/022; B29K 2105/0038

(57) ABSTRACT

A PCM-containing composition described herein includes at least the following components: a PCM-containing plasticizer component; and a scaffold component, which may or may not contain a PCM. The latent heat of fusion of the scaffold component used in these compositions is from 50 J/g to 250 J/g less, or from 75 J/g to 250 J/g less, than a latent heat of fusion of the PCM-containing plasticizer component. Also described herein is a method of forming extruded objects that includes extruding an extrusion mixture of a PCM-containing plasticizer component and a scaffold component. The PCM-containing compositions, or extruded objects formed from the composition may be used for controlling temperature and/or storing thermal energy at a desired temperature for a particular end-use, e.g., vaccine storage or transport, pharmaceutical storage or transport, food storage or transport, etc.

### RELATED APPLICATION DATA

This application claims priority under 35 U.S.C. § 119(e) to U.S. Provisional Patent Application No. 63/415,106, filed on Oct. 11, 2022, which is incorporated by reference herein in its entirety.

### FIELD

The present disclosure relates generally to compounds containing phase change materials and methods of controlling temperature using the same.

### BACKGROUND

In recent years, latent heat storage has become increasingly important in a wide array of technologies. Latent heat includes thermal energy released or absorbed during a change of state of a material without a substantial change in the temperature of the material. The change of state can include a phase change such as a solid-liquid, solid-gas, liquid-gas, or solid-solid phase change, including a crystalline solid to amorphous solid phase change.

Due to their latent heat storage properties, phase change materials (PCMs) have found application in a wide array of thermal energy technologies. However, the use of PCMs has been somewhat limited by disadvantages associated with the phase changes exhibited by some PCMs, including large volume changes, slow transitions, flow in a liquid state, lack of operable phase transition temperature ranges, and/or insufficient latent heats within certain desired phase transition temperature ranges.

### DESCRIPTION

In the following detailed description of the embodiments of the instant disclosure, numerous specific details are set forth in order to provide a thorough understanding of the disclosed embodiments. However, it will be obvious to one skilled in the art that the embodiments of this disclosure may be practiced without these specific details. In other instances, well known methods, procedure, components, and circuits have not been described in detail so as not to unnecessarily obscure aspects of the embodiments of the instant disclosure.

The following explanations of terms and methods are provided to better describe the present disclosure and to guide those of ordinary skill in the art in the practice of the present disclosure. The singular terms “a,” “an,” and “the” include plural referents unless context clearly indicates otherwise. Similarly, the word “or” is intended to include “and” unless the context clearly indicates otherwise. The term “comprises” means “includes.” Thus, “comprising A or B,” means “including A, B, or A and B,” without excluding additional elements. The term “about” will be understood by persons of ordinary skill in the art. Whether the term “about” is used explicitly or not, every quantity given herein refers to the actual given value, and it is also meant to refer to the approximation to such given value that would be reasonably inferred based on the ordinary skill in the art.

Compositions described herein may provide one or more advantages in the manufacture of housings or cases for electronics or lighting in high-temperature environments. Additionally, in certain embodiments, compositions described herein may facilitate the manufacture of heat exchangers or heatsinks for power generators used at high temperatures and/or for waste heat recovery. However, compositions described herein are not limited to such applications and may provide a wide array of benefits in many industrial and consumer applications.

Described herein are compositions (or PCM-containing compositions) comprising, consists of, or consists essentially of at least (1) a phase change material (PCM) containing plasticizer component and (2) a scaffold component. The scaffold component, in some embodiments, comprises a PCM. In certain other embodiments, the scaffold component does not comprise a PCM.

Compositions described herein comprise at least a PCM-containing plasticizer component. Not intending to be bound by theory, a plasticizing component or plasticizing material may contribute one or more desirable physical properties to the overall composition such as, without limitation, rigidity modulation, reduction or increase in deformation force required at a target temperature, tensile strength modulation, or impact strength modulation.

A PCM-containing plasticizer component comprises, consists of, or consists essentially of at least one phase change material, e.g., a first PCM component. Depending on the desired phase transition temperature (e.g., melting temperature) the first PCM component, in some embodiments, may include an organic PCM. Suitable organic PCMs may include any of the following, or derivatives or mixtures thereof: a) a fatty acid such as caprylic acid, capric acid, lauric acid, mystiric acid, palmitic acid, stearic acid, arachidic acid, behenic acid, or a plurality of differing fatty acids; b) a fatty alcohol such as capryl alcohol, capric alcohol, lauryl alcohol, mystiryl alcohol, cetyl alcohol, stearyl alcohol, or a plurality of differing fatty alcohols; c) an alkyl ester of a fatty acid such as methyl laurate, methyl mystirate, methyl palmitate, methyl stearate, methyl palmitoleate, methyl oleate, the corresponding ethyl, propyl, or butyl esters (e.g., ethyl myristate, propyl myristate, or butyl myristate as the corresponding ethyl, propyl, or butyl ester of methyl myristate); d) a sugar alcohol such as D-mannitol, xylitol, D-sorbitol, erythritol, mannitol, or galactitol; e) an organic acid such as, without limitation, certain mono- or di-carboxylic acids or other acids not containing a carboxylic acid substituent such as glutaric acid, pimelic acid, azelaic acid, mandelic acid, benzoic acid, sebacic acid (dicarboxylic acid), urea, maleic acid, suberic acid, and/or salicylic acid; f) a polyethylene glycol (PEG) such as, without limitation, PEG 3000 (indicating a molar mass of 3,000 g/mol), PEG 3400, PEG 6000, PEG 10000, PEG 20000, PEG 35000, PEG 100000, or PEG 1000000; and/or trimethylolethane (TME) and its structural or chemical analogs. In some embodiments, the first PCM component may comprise or include a eutectic mixture of one or more of the foregoing suitable organic PCMs.

For example, in some embodiments, the organic PCM comprises, consists of, or consists essentially of methyl laurate, butyl myristate, propyl myristate, or combinations thereof (for a phase transition temperature (melting temperature) in the range of 2-10° C.). In certain other embodiments, the organic PCM comprises, consists of, or consists essentially of myristic acid (for a phase transition temperature (melting temperature) in the range of 55-60° C.).

A PCM-containing plasticizer component may also further comprise, consist of, or consist essentially of a biopolymer. Non-limiting examples of biopolymers suitable for use in some embodiments described herein include methyl-, ethyl-, propyl-carboxy-, hydroxymethyl-, hydroxyethyl-, hydroxypropyl, hydroxypropylmethyl-, hydroxypropylethyl-, carboxymethyl-, carboxyethyl-, and carboxypropyl-derivatives of cellulose, guar, starch, and other polysaccharides. Some preferred biopolymers include cellulose and guar functionalized with one or more of the functional groups listed above.

Additionally, in some implementations, a PCM-containing plasticizer component of a composition described herein may further comprise, consist of, or consist essentially of an ionic liquid component. In some instances, the ionic liquid component acts as a plasticizer in lieu of or in addition to the PCM's plasticization properties. In certain other embodiments, the ionic liquid component is not a plasticizer. In some embodiments, an ionic liquid is imidazolium-based. In other embodiments, an ionic liquid is pyridinium-based. In some embodiments, an ionic liquid is choline-based. Further, in some embodiments, an ionic liquid comprises, consists of, or consists essentially of a sugar, sugar alcohol, or sugar derivative, such as glycol-choline, glycerol-choline, erythritol-choline, threitol-choline, arabitol-choline, xylitol-choline, ribitol-choline, mannitol-choline, sorbitol-choline, dulcitol-choline, iditol-choline, isomalt-choline, maltitol-choline, or lactitol-choline. Further, in some embodiments, an ionic liquid is ammonium-based. Additionally, and/or alternatively, in some implementations, a PCM-containing plasticizer component comprises, consists of, or consists essentially of an ionic liquid component as a primary or majority share of the PCM-containing plasticizer component's composition. Thus, in certain embodiments, the PCM-containing plasticizer component may comprise, consist, or consist essentially of one or more ionic liquids. Not intending to be bound by theory, in some such implementations, the ionic liquid or liquids contribute greater than 50% of the PCM-containing plasticizer component's latent heat or thermal energy storage capacity, such as between about 50% and about 100%, between about 50% and about 75%, or between about 75% and about 100% of the latent heat or thermal energy storage capacity of the PCM-containing plasticizer component. Non-limiting examples of ionic liquids suitable for use in some embodiments described herein include 1-Allyl-3-methylimidazolium bis(trifluoromethylsulfonyl)imide, 1-Allyl-3-methylimidazolium bromide, 1-Allyl-3-methylimidazolium dicyanamide, 1-Allyl-3-methylimidazolium iodide, 1-Benzyl-3-methylimidazolium chloride, 1-Benzyl-3-methylimidazolium hexafluorophosphate, 1-Benzyl-3-methylimidazolium tetrafluoroborate, 1,3-Bis(3-cyanopropyl) imidazolium bis(trifluoromethylsulfonyl)imide, 1,3-Bis(3-cyanopropyl) imidazolium chloride, 1-Butyl-2,3-dimethylimidazolium hexafluorophosphate, 1-Butyl-2,3-dimethylimidazolium tetrafluoroborate, 4-(3-Butyl-1-imidazolio)-1-butanesulfonate, 1-Butyl-3-methylimidazolium acetate, 1-Butyl-3-methylimidazolium chloride, 1-Butyl-3-methylimidazolium dibutyl phosphate, 1-Butyl-3-methylimidazolium hexafluorophosphate, 1-Butyl-3-methylimidazolium nitrate, 1-Butyl-3-methylimidazolium octyl sulfate, 1-Butyl-3-methylimidazolium tetrachloroaluminate, 1-Butyl-3-methylimidazolium tetrafluoroborate, 1-Butyl-3-methylimidazolium thiocyanate, 1-Butyl-3-methylimidazolium tosylate, 1-Butyl-3-methylimidazolium trifluoroacetate, 1-Butyl-3-methylimidazolium trifluoromethanesulfonate, 1-(3-Cyanopropyl)-3-methylimidazolium bis(trifluoromethylsulfonyl)amide, 1-Decyl-3-methylimidazolium tetrafluoroborate, 1,3-Diethoxyimidazolium bis(trifluoromethylsulfonyl)imide, 1,3-Diethoxyimidazolium hexafluorophosphate, 1,3-Dihydroxyimidazolium bis(trifluoromethylsulfonyl)imide, 1,3-Dihydroxy-2-methylimidazolium bis(trifluoromethylsulfonyl)imide, 1,3-Dimethoxy-2-methylimidazolium hexafluorophosphate, 1-Dodecyl-3-methylimidazolium iodide, 1-Ethyl-2,3-dimethylimidazolium tetrafluoroborate, 1-Ethyl-3-methylimidazolium hexafluorophosphate, 1-Ethyl-3-methylimidazolium L-(+)-lactate, 1-Ethyl-3-methylimidazolium 1,1,2,2-tetrafluoroethanesulfonate, 1-Hexyl-3-methylimidazolium bis(trifluormethylsulfonyl)imide, 1-Hexyl-3-methylimidazolium chloride, 1-Hexyl-3-methylimidazolium hexafluorophosphate, 1-Methylimidazolium chloride, 1-Methyl-3-octylimidazolium chloride, 1-Methyl-3-octylimidazolium tetrafluoroborate, 1-Methyl-3-propylimidazolium iodide, 1-Methyl-3-(3,3,4,4,5,5,6,6,7,7,8,8,8-tridecafluorooctyl) imidazolium hexafluorophosphate, 1,2,3-Trimethylimidazolium methyl sulfate, 1-Butyl-4-methylpyridinium chloride, 1-Butyl-4-methylpyridinium hexafluorophosphate, 1-Butylpyridinium bromide, 1-(3-Cyanopropyl)pyridinium chloride, 1-Ethylpyridinium tetrafluoroborate, 3-Methyl-1-propylpyridinium bis(trifluormethylsulfonyl)imide, Cholin acetate, butyltrimethylammonium bis(trifulormethylsulfonyl)imide, Diethylmethyl (2-methoxyethyl) ammonium bis(trifluoromethylsulfonyl)imide, Ethyldimethylpropylammonium bis(trifluoromethylsulfonyl) imide, 20Hydroxyethyl-trimethylammonium L-(+)-lactate, Methyl-trioctylammonium bis(trifuloromethylsulfonyl)imide, Methyltrioctylammonium hydrogen sulfate, Methyltrioctylammonium thiosalicylate, Tetrabutylammonium benzoate, Tetrabutylammonium bis-trifluoromethanesulfonimidate, Tetrabutylammonium bis-trifluoromethanesulfonimidate, Tetrabutylammonium heptacafluorooctanesulfonate, Tetrabutylammonium hydroxide 30-hydrate, Tetrabutylammonium methanesulfonate, Tetrabutylammonium nitrate, Tetrabutylammonium nonfluorobutanesulfonate, Tetrabutylammonium triiodide, Tetradodecylammonium bromide, Tetradodecylammonium bromide, Tetradodecylammonium chloride, tetraethylammonium trifluoromethanesulfonate, Tetraheptylammonium bromide, Tetrahexylammonium hydrogensulfate, Tetrahexylammonium iodide, Tetrahexylammonium tetrafluoroborate, Tetrakis(decyl) ammonium bromide, Tetramethylammonium hydroxide pentahydrate, Tetraoctylammonium chloride, Tributylmethylammonium chloride, Tributylmethylammonium dibutyl phosphate, Tributylmethylammonium methyl carbonate solution in methanol:water (2:3), Tris(2-hydroxyethyl)methylammonium methylsulfate, and mixtures or combinations thereof, all available commercially from Sigma-Aldrich.

Further, in some embodiments, a PCM-containing plasticizer component of compositions described herein comprises, consists of, of consists essentially of one or more anhydrous salts and/or aqueous solutions formed from one or more anhydrous salts. Additionally, in some such embodiments, the PCM-containing plasticizer component may comprise or include a eutectic solution comprising or including two or more, such as three or more anhydrous salts and or aqueous solutions formed from two or more, such as three or more anhydrous salts.

Additionally, a PCM-containing plasticizer component can comprise, consist of, or consist essentially of any of the above mentioned components in combination with any other of the above mentioned components. This includes, without limitation, organic PCMs, ionic liquids, biopolymers, and/or anhydrous salts. Such combinations can specifically comprise or include mixtures such as eutectic solutions of the combined materials.

The scaffold component of the compositions described herein may optionally comprise or include a second PCM-containing component. The second PCM-containing component may comprise, consist of, or consist essentially of any material not inconsistent with the above-discussed first PCM-containing component. However, in certain embodiments, the scaffold component is not a PCM or does not contain a PCM. Alternatively, and/or additionally, in some instances, the scaffold component has a phase transition temperature (melting temperature) which is higher than a PCM of the PCM-containing plasticizer component, and may optionally be substantially higher than a phase transition temperature of a PCM of the PCM-containing plasticizer component. For example, a phase transition temperature (melting temperature) of the scaffold component may be at least 25° C. higher than a phase transition temperature (melting temperature) of the PCM-containing plasticizer component, such as between 25° C. and 200° C. higher. For example, in some embodiments, the scaffold component has a phase transition temperature (melting temperature) which is between 50° C. and 200° C. higher, between 60° C. and 200° C. higher, between 75° C. and 200° C. higher, between 80° C. and 200° C. higher, or between 100° C. and 200° C. higher than a phase transition temperature (melting temperature) of the PCM-containing plasticizer. Further, in some embodiments, the scaffold component has a phase transition temperature (melting temperature) which is between 50° C. and 175° C. higher, between 50° C. and 150° C. higher, between 50° C. and 125° C. higher, between 50° C. and 100° C. higher, or between 50° C. and 75° C. higher than a phase transition temperature (melting temperature) of the PCM-containing plasticizer component.

Alternatively, and/or additionally, the scaffold component has a phase change enthalpy or latent heat which is substantially lower than a phase change enthalpy or latent heat of the PCM-containing plasticizer component. For example, a latent heat of fusion (melting) of the scaffold component is at least 50 J/g less or at least 75 J/g less than a latent heat of fusion (melting) of the PCM-containing plasticizer component, such as between 50 J/g and 250 J/g less than a latent heat of fusion (melting) of the PCM-containing plasticizer component, between 50 J/g and 200 J/g less than a latent heat of fusion (melting) of the PCM-containing plasticizer component, between 50 J/g and 150 J/g less than a latent heat of fusion (melting) of PCM-containing plasticizer component, between 50 J/g and 100 J/g less than a latent heat of fusion (melting) of the PCM-containing plasticizer component, or between 100 J/g and 250 J/g less than a latent heat of fusion (melting) of the PCM-containing plasticizer component. In some embodiments, a latent heat of fusion (melting) of the scaffold component is between 75 J/g and 250 J/g less than that of the PCM-containing plasticizer component.

Compositions described herein, in some embodiments, are suitable as build materials for additive manufacturing or 3D printing. Suitable additive manufacturing technologies with compositions described herein may include, without limitation, fused deposition modeling (FDM), however other additive manufacturing techniques may also be consistent with the present disclosure, such as material jetting (MJ), drop on demand (DOD), or binder jetting. Thus, in some embodiments, the scaffold component may, in some embodiments, comprise, consist of, or consist essentially of one or more materials which may be suitable for an additive manufacturing process without the inclusion of a PCM-containing plasticizer. Therefore, a scaffold component may comprise, consist of, or consist essentially of one or more materials or a mixture of materials which may be suitable for such purpose, without limitation, such as: polylactic acid (PLA); acrylonitrile butadiene styrene (ABS); polyethylene terephthalate (PET); polyethylene terephthalate glycol (PETG); and thermoplastic polyurethane (TPU); styrenic block copolymers (SBCs or SBC elastomers) (such as those commercially available from KRATON™ Corporation and KURARAY AMERICA under the name SEPTON™ elastomers) including di-block and tri-block copolymers; polyethylene polymers including, without limitation, ultra-high-molecular-weight polyethylene (UHMWPE), ultra-low-molecular-weight polyethylene (ULMWPE or PE-WAX), high-molecular-weight polyethylene (HMWPE), high-density polyethylene (HDPE), high-density cross-linked polyethylene (HDXLPE), cross-linked polyethylene (PEX or XLPE), medium-density polyethylene (MDPE), linear low-density polyethylene (LLDPE), low-density polyethylene (LDPE), very-low-density polyethylene (VLDPE); and/or chlorinated polyethylene (CPE); nylon (synthetic polymers comprising, consisting, or consisting essentially of polyamides) and/or combinations or mixtures thereof. Scaffold component(s) may additionally and/or alternatively comprise, consist of, or consist essentially of one or more thermoplastic elastomers (TPEs) not explicitly identified in the foregoing.

Consistent with the foregoing, compositions described herein may formed from any ratio of PCM-containing plasticizer component to scaffold component not inconsistent with the objectives of the present disclosure. For example, in some embodiments, a ratio of PCM-containing plasticizer component to scaffold component by weight percent (wt.-%) is between 10:90 and 90:10, such as between 15:85 and 85:15, between 20:80 and 80:20, between 25:75 and 75:25, between 30:70 and 70:30, between 35:65 and 65:35, or between 40:60 and 60:40. In some embodiments, however, a composition described herein comprises less than 50 wt.-% of a PCM-containing plasticizer component, such as between 1 wt.-% and 50 wt.-%, between 5 wt.-% and 50 wt.-%, between 10 wt.-% and 50 wt.-%, between 15 wt.-% and 50 wt.-%, between 20 wt.-% and 50 wt.-%, or between 25 wt.-% and 50 wt.-%. Moreover, in some embodiments, a composition described herein comprises less than or equal to 30 wt.-% of a PCM-containing plasticizer component, such as between 1 wt.-% and 30 wt.-%, between 5 wt.-% and 30 wt.-%, between 10 wt.-% and 30 wt.-%, or between 15 wt.-% and 30 wt.-% PCM-containing plasticizer component.

Disclosed herein are compositions (or PCM-containing compositions) comprising, consisting of, or consisting essentially of at least a PCM-containing plasticizer component comprising, consisting of or consisting essentially of a first PCM component and a scaffold component which may optionally comprise (or may not comprise) a second PCM component. Compositions disclosed herein are, or include, a stable PCM composition with advantageous thermal, physical, and chemical properties. In some embodiments, compositions described herein have a latent heat of fusion (melting) in excess of 100 J/g (or in excess of 150 J/g, or 200 J/g, or 250 J/g). Additionally, and/or alternatively, in some embodiments, a PCM-containing plasticizer component of a composition herein has a latent heat of fusion (melting) in excess of 100 J/g (or in excess of 150 J/g, or 200 J/g, or 250 J/g).

A PCM of a composition described herein can have one or more properties as may be desired. For example, in some embodiments, the PCM (PCM component) has a latent heat of fusion (melting) or phase transition (melting) enthalpy of at least about 50 J/g or at least about 100 J/g. In other embodiments, a PCM (PCM component) of a composition described herein has a latent heat of fusion (melting) of at least about 150 J/g, at least about 200 J/g, at least about 300 J/g, or at least about 350 J/g. In some instances, a PCM (PCM component) of a composition described herein has a latent heat of fusion (melting) between about 50 J/g and about 400 J/g, between about 100 J/g and about 400 J/g, between about 100 J/g and about 220 J/g, between about 100 J/g and about 250 J/g, or between about 100 J/g and about 325 J/g. In certain instances, a PCM (PCM component) of a composition described herein has a latent heat of fusion (melting) of between about 75 J/g and about 225 J/g, between about 100 J/g and about 250 J/g, between about 125 J/g and 275 J/g, between about 150 J/g and about 300 J/g, between about 200 J/g and about 400 J/g, or between about 300 J/g and about 400 J/g.

Additionally, a PCM (PCM component) of a composition described herein can have any phase transition temperature not inconsistent with the objectives of the present invention. For example, in some embodiments, a PCM has a phase transition temperature below 0° C. As understood by one having ordinary skill in the art, a phase transition temperature described herein (such as a phase transition temperature of “X” ° C., where X may be −20° C., for example) may be represented as a normal distribution of temperatures centered on X° C. In addition, as understood by one having ordinary skill in the art, a PCM (PCM component) described herein can exhibit thermal hysteresis, such that the PCM exhibits a phase change temperature difference between the “forward” phase change and the “reverse” phase change (e.g., a solidification temperature that is different from the melting temperature). In some embodiments, the PCM has a phase transition temperature, e.g., a melting temperature, within one of the ranges of Table I below.

TABLE I
Phase transition temperature ranges for PCMs (at a pressure of 1 atm.).
Phase Transition Temperature Ranges

| | |
|---|---|
| 2-175° | C. |
| 2-10° | C. |
| 10-30° | C. |
| 15-30° | C. |
| 15-25° | C. |
| 30-45° | C. |
| 40-100° | C. |
| 70-110° | C. |
| 100-175° | C. |

Further, a PCM (PCM component) of a composition described herein can either absorb or release energy using any phase transition not inconsistent with the objectives of the present disclosure. For example, the phase transition of a PCM described herein, in some embodiments, comprises a transition between a solid phase and a liquid phase of the PCM (i.e., melting of the PCM), or between a solid phase and a mesophase of the PCM. A mesophase, in some cases, is a gel phase. Thus, in some instances, a PCM undergoes a solid-to-gel transition.

Further, in some embodiments, one or more properties of a PCM (PCM component) described herein can be modified by the inclusion of one or more additives. Such an additive described herein can be mixed with a PCM (PCM component) or otherwise added to a composition described herein. In some embodiments, an additive comprises a thermal conductivity modulator. A thermal conductivity modulator, in some embodiments, increases the thermal conductivity of the PCM (PCM component). In some embodiments, a thermal conductivity modulator comprises, consists of, or consists essentially of carbon, including graphitic carbon. In some embodiments, a thermal conductivity modulator comprises, consists of, or consists essentially of carbon black and/or carbon nanoparticles. Carbon nanoparticles, in some embodiments, comprise, consist of, or consist essentially of carbon nanotubes and/or fullerenes. In some embodiments, a thermal conductivity modulator comprises, consists of, or consists essentially of a graphitic matrix structure. In other embodiments, a thermal conductivity modulator comprises, consists of, or consists essentially of an ionic liquid. In some embodiments, a thermal conductivity modulator comprises, consists of, or consists essentially of a metal, including a pure metal or a combination, mixture, or alloy of metals. Any metal not inconsistent with the objectives of the present disclosure may be used. In some embodiments, a metal comprises, consists of, or consists essentially of a transition metal, such as silver or copper. In some embodiments, a metal comprises, consists of, or consists essentially of an element from Group 13 or Group 14 of the periodic table. In some embodiments, a metal comprises, consists of, or consists essentially of aluminum. In some embodiments, a thermal conductivity modulator comprises, consists of, or consists essentially of a metallic filler dispersed within a matrix formed by the PCM. In some embodiments, a thermal conductivity modulator comprises, consists of, or consists essentially of a metal matrix structure or cage-like structure, a metal tube, a metal plate, and/or metal shavings. Further, in some embodiments, a thermal conductivity modulator comprises, consists of, or consists essentially of a metal oxide. Any metal oxide not inconsistent with the objectives of the present disclosure may be used. In some embodiments, a metal oxide comprises, consists of, or consists essentially of a transition metal oxide. In some embodiments, a metal oxide comprises, consists of, or consists essentially of alumina.

In other embodiments, an additive comprises, consists of, or consists essentially of a nucleating agent. A nucleating agent, in some embodiments, can help avoid sub-cooling, particularly for PCMs comprising finely distributed phases, such as fatty alcohols, paraffinic alcohols, amines, paraffins, or for certain salt hydrate containing solutions. Any nucleating agent not inconsistent with the objectives of the present disclosure may be used. In still other instances, an additive comprises, consists of, or consists essentially of a fire retardant or fire-resistant material.

Additionally, in some cases, the composition further comprises, consists of, or consists essentially of a fire retardant. Any fire retardant not inconsistent with the objectives of the present invention may be used. In some embodiments, a fire retardant comprises, consists of, or consists essentially of a foam. Further, in some cases, a fire retardant can comprise, consist of, or consist essentially of an organic composition or an inorganic composition. In some instances, a fire retardant comprises, consists of, or consists essentially of a phosphate, such as ammonium phosphate, trisodium phosphate, triphenyl phosphate, tricresylphosphate, tris(2-chloroethyl)phosphate, tris(2-chloro-1-(chloromethyl)ethyl)phosphate, tris(chloropropyl)phosphate, tris(1,3-dichloro-2-propyl)phosphate, or tetrekis (2-chlorethyl)dichloroisopentyldiphosphate. In some embodiments, a fire retardant comprises, consists of, or consists essentially of aluminum hydroxide and/or magnesium hydroxide.

A fire retardant may also comprise, consists of, or consists essentially of a zeolite. Any zeolite not inconsistent with the objectives of the present disclosure may be used. In some cases, a zeolite comprises a natural zeolite. In other embodiments, a zeolite comprises, consists of, or consists essentially of an artificial zeolite. In some instances, a zeolite comprises, consists of, or consists essentially of a silicate and/or aluminosilicate. In some implementations, a zeolite comprises, consists of, or consists essentially of a composition according to the formula M_{x/n} [(AlO₂)ₓ(SiO₂)_{y}]·w H₂O, where n is the valence of cation M (e.g., Na⁺, K⁺, Ca²⁺, or Mg²⁺), wis the number of water molecules per unit cell, and x and y are the total number of tetrahedral atoms per unit cell. Non-limiting examples of zeolites suitable for use in some embodiments described herein include analcime ((K,Ca,Na) AlSi₂O₆⋅ H₂O), chabazite ((Ca,Na₂,K₂,Mg) Al₂Si₄O₁₂⋅6H₂O), clinoptilolite ((Na,K,Ca)₂₋₃Al₃(Al, Si)₂Si₁₃O₃₆ ⋅12H₂O), heulandite ((Ca,Na)₂₋₃Al₃(Al,Si)₂Si₁₃O₃₆⋅12H₂O), natrolite (Na₂Al₂Si₃O₁₀ ⋅2H₂O), phillipsite ((Ca,Na₂,K₂)₃Al₆Si₁₀O₃₂⋅12H₂O), and stilbite (NaCa₄(Si₂₇Al₉)O₇₂⋅28 (H₂O)).

Moreover, in some instances, a composition described herein further comprises, consists of, or consists essentially of an antimicrobial material. Any antimicrobial material not inconsistent with the objectives of the present disclosure may be used. An antimicrobial material, in some cases, comprises, consists of, or consists essentially of an inorganic composition, including metals and/or metal salts. In some embodiments, for example, an antimicrobial material comprises, consists of, or consists essentially of metallic copper, zinc, or silver or a salt of copper, zinc, or silver. Moreover, in some instances, an antimicrobial material comprising a metal can also provide thermal conductivity modulation. In other embodiments, an antimicrobial material comprises, consists of, or consists essentially of an organic composition, including natural and synthetic organic compositions. In some cases, an antimicrobial material comprises, consists of, or consists essentially of a β-lactam such as a penicillin or cephalosporin. In some implementations, an antimicrobial material comprises, consists of, or consists essentially of a protein synthesis inhibitor such as neomycin. In some embodiments, an antimicrobial material comprises, consists of, or consists essentially of an organic acid, such as lactic acid, acetic acid, or citric acid. In some cases, an antimicrobial material comprises, consists of, or consists essentially of a quarternary ammonium species. A quarternary ammonium species, in some embodiments, comprises a long alkyl chain, such as an alkyl chain having a C8 to C28 backbone. In some instances, an antimicrobial material comprises, consists of, or consists essentially of one or more of benzalkonium chloride, benzethonium chloride, methylbenzethonium chloride, cetalkonium chloride, cetylpyridinium chloride, cetrimonium, cetrimide, dofanium chloride, tetraethylammonium bromide, didecyldimethylammonium chloride, and domiphen bromide.

In another aspect, methods of forming extruded objects such as filaments, bricks, and the like are described herein. In some embodiments, a method comprises combining a solid pelletized PCM-containing plasticizer component and a solid pelletized scaffold component in a container to form a solid extrusion mixture; heating the solid extrusion mixture to a temperature at or above a melting point of both the solid pelletized PCM-containing plasticizer component and the solid pelletized scaffold component to form a pre-extrusion melt mixture; mixing the pre-extrusion melt mixture; and extruding the pre-extrusion melt mixture to form an extruded object such as a filament, a brick, or the like. Any PCM-containing plasticizer consistent with the above disclosure may be used. Any scaffold component consistent with the above disclosure may be used. In some embodiments, the filaments produced are suitable for use in an additive manufacturing operation.

In another aspect, methods for controlling temperature and/or storing thermal energy using the compositions (PCM-containing compositions) described hereinabove are disclosed. For example, temperature may be controlled and/or thermal energy may be stored in a range from −100° C. to 50° C. At a minimum, the method comprises, consists of, or consists essentially of a step of providing the compositions described herein. The provided composition controls temperature (and stores thermal energy) by absorbing heat from the environment without significantly changing temperature. The ability of the composition to control temperature (and store thermal energy) is due largely in part to the presence of one or more PCMs (PCM components). For example, a PCM may be chosen such that a phase transition temperature, e.g., a melting point, of the PCM occurs at a temperature that falls within a range in which temperature control and/or thermal energy storage is desired. This range will depend on use, e.g., a range of 2° C. to 8° C. is known to be useful for pharmaceutical storage and short-term, e.g., less than a week, vaccine storage.

For example, in some embodiments, the composition may be provided in a vessel, e.g., as inserts into, or as part of vessel, e.g., the vessel is made from the composition, for storing and/or transporting vaccines, food, pharmaceuticals, or biological samples. In such embodiments, temperature is controlled and/or thermal energy is stored in a range from about-90° C. to about 10° C. For example, temperature control and/or thermal energy storage in a range of −90° C. to −60° C. is useful for long term storage, e.g., 1 to 6 months, of vaccines, including mRNA vaccines. Temperature control and/or thermal energy storage in a range of −40° C. to −15° C. is useful for vaccine storage, including shorter term storage, e.g., 1 month or less, of mRNA vaccines. It is also useful for meat storage. Temperature control and/or thermal energy storage in a range of −0° C. to 10° C. is useful for fruit, vegetable, fresh meat, and dairy product storage. Temperature control and/or thermal energy storage in a range of 2° C. to 8° C. is useful for pharmaceutical storage and short-term, e.g., less than a week, vaccine storage.

In alternative embodiments, the PCM-containing composition may be provided, e.g., as a layer, in direct or indirect contact with a photovoltaic cell or panel. Indirect contact means that the composition is not in direct contact with, i.e., touching, the photovoltaic cell or panel, but heat can still be transferred from the photovoltaic cell or panel to the composition. For example, indirect contact may mean that additional layers are provided between the photovoltaic cell or panel and a layer including the PCM-containing compositions described herein. In such embodiments, temperature may be controlled and/or thermal energy may be stored in a range of 30° C. to 45° C.

In alternative embodiments, the PCM-containing compositions may be provided as part of a telecom component or device. For a telecom component or device, the PCM-containing compositions may be used to form, for example, cells or panels typically containing PCMs in devices such as telecom shelters. In such embodiments, temperature may be controlled and/or thermal energy may be stored in a range of 20° C. to 35° C.

For an electronic component or device, the PCM-containing compositions may be provided, e.g., as a coating layer, in direct or indirect contact with electronic components that get hot to provide thermal management. Indirect contact means that the PCM-containing composition is not in direct contact with, i.e., touching, the electronic component that gets hot, but heat can still be transferred from the electronic component that gets hot to the composition. In some embodiments, the PCM-containing material may be provided as a layer in contact with an electrode of a secondary batter, e.g., a lithium ion battery. Alternatively, in secondary batteries, e.g., lithium ion batteries, the PCM-containing compositions may be wrapped or otherwise provided around individual battery cells. In other embodiments, a battery separator or other battery component may be formed using the PCM-containing compositions. In such embodiments, temperature may be controlled and/or thermal energy may be stored in a range of 50° C. to 150° C. In secondary batteries, temperatures should remain below 150° C., and ideally less than 60° C. At temperatures above 60° C., electrolyte decomposition and electrode decomposition may occur.

### EXAMPLES

Certain non-limiting inventive embodiments are described in Table 1 provided herein below:

TABLE 1

| | | PCM-containing | |
|---|---|---|---|
| | | plasticizer | Scaffold |
| | | component and | Component and |
| Applications | | amount (%) | amount (%) |
| Long Term | Example 1 | Ethyl Acetate | styrenic block |
| Frozen | | (50%) | copolymer (50%) |
| (−90° C. | Example 2 | Methyl Caproate | styrenic block |
| to −50° C.) | | (50%) | copolymer (50%) |
| | Example 3 | Methyl Linolenate | styrenic block |
| | | (50%) | copolymer (50%) |
| Frozen | Example 4 | Methyl Oleate | styrenic block |
| (−40° C. | | (50%) | copolymer (50%) |
| to −15° C.) | Example 5 | Methyl Linoleate | styrenic block |
| | | (50%) | copolymer (50%) |
| | Example 6 | Methyl caprylate | styrenic block |
| | | (50%) | copolymer (50%) |
| Chilled | Example 7 | Methyl laurate | Polylactic acid |
| (0° C. to | | (80%) | (20%) |
| 10° C.) | Example 8 | Propyl myristate | polylactic acid |
| | | (50%) | (50%) |
| | Example 9 | Methyl laurate | acrylonitrile |
| | | (50%) | butadiene styrene |
| | | | (50%) |
| | Example 10 | Propyl myristate | acrylonitrile |
| | | (50%) | butadiene |
| | | | styrene(50%) |
| | Example 11 | Methyl laurate | polyethylene |
| | | (50%) | terephthalate (50%) |
| | Example 12 | Propyl myristate | polyethylene |
| | | (50%) | terephthalate(50%) |
| | Example 13 | Methyl laurate | polyethylene |
| | | (50%) | terephthalate glycol |
| | | | (50%) |
| | Example 14 | Propyl myristate | polyethylene |
| | | (50%) | terephthalate glycol |
| | | | (50%) |
| | Example 15 | Methyl laurate | thermoplastic |
| | | (50%) | polyurethane (50%) |
| | Example 16 | Propyl myristate | thermoplastic |
| | | (50%) | polyurethane (50%) |
| | Example 17 | Methyl laurate | styrenic block |
| | | (50%) | copolymer (50%) |
| | Example 18 | Propyl myristate | styrenic block |
| | | (50%) | copolymer (50%) |
| | Example 19 | Methyl laurate | polyethylene |
| | | (50%) | polymer (50%) |
| | Example 20 | Propyl myristate | polyethylene |
| | | (50%) | polymer(50%) |
| | Example 21 | Methyl laurate | nylon material |
| | | (50%) | (50%) |
| | Example 22 | Propyl myristate | nylon material(50%) |
| | | (50%) | |
| | Example 23 | Methyl laurate | thermoplastic |
| | | (50%) | elastomer (50%) |
| | Example 24 | Propyl myristate | thermoplastic |
| | | (50%) | elastomer (50%) |
| Sensitive | Example 25 | Methyl laurate | Polylactic acid |
| (2° C. to | | (50%) | (50%) |
| 8° C.) | Example 26 | Propyl myristate | polylactic acid |
| | | (50%) | (50%) |
| | Example 27 | Methyl laurate | acrylonitrile |
| | | (50%) | butadiene |
| | | | styrene(50%) |
| | Example 28 | Propyl myristate | acrylonitrile |
| | | (50%) | butadiene styrene |
| | | | (50%) |
| | Example 29 | Methyl laurate | polyethylene |
| | | (50%) | terephthalate (50%) |
| | Example 30 | Propyl myristate | polyethylene |
| | | (50%) | terephthalate (50%) |
| | Example 31 | Methyl laurate | polyethylene |
| | | (50%) | terephthalate glycol |
| | | | (50%) |
| | Example 32 | Propyl myristate | polyethylene |
| | | (50%) | terephthalate glycol |
| | | | (50%) |
| | Example 33 | Methyl laurate | thermoplastic |
| | | (50%) | polyurethane (50%) |
| | Example 34 | Propyl myristate | thermoplastic |
| | | (50%) | polyurethane (50%) |
| | Example 35 | Methyl laurate | styrenic block |
| | | (50%) | copolymer (50%) |
| | Example 36 | Propyl myristate | styrenic block |
| | | (50%) | copolymer (50%) |
| | Example 37 | Methyl laurate | polyethylene |
| | | (50%) | polymer (50%) |
| | Example 38 | Propyl myristate | polyethylene |
| | | (50%) | polymer(50%) |
| | Example 39 | Methyl laurate | nylon material |
| | | (50%) | (50%) |
| | Example 40 | Propyl myristate | nylon material(50%) |
| | | (50%) | |
| | Example 41 | Methyl laurate | thermoplastic |
| | | (50%) | elastomer (50%) |
| | Example 42 | Propyl myristate | thermoplastic |
| | | (50%) | elastomer (50%) |
| | Example 43 | Lauryl Alcohol | thermoplastic |
| | | (75%) | elastomer (75%) |
| | Example 44 | Methyl Palmitate | thermoplastic |
| | | (75%) | elastomer (75%) |
| Telecom | Example 45 | Ethyl Palmitate | thermoplastic |
| (20° C. to | | (75%) | elastomer (75%) |
| 35° C.) | Example 46 | Lauryl Alcohol | polylactic acid |
| | | (75%) | (25%) |
| | Example 47 | Ethyl Palmitate | thermoplastic |
| | | (75%) | elastomer (75%) |
| | Example 48 | Lauryl Alcohol | thermoplastic |
| | | (75%) | elastomer (75%) |
| Solar | Example 49 | Methyl Palmitate | polyethylene |
| (30° C. to | | (75%) | terephthalate (25%) |
| 45° C.) | Example 50 | Capric Acid | polyethylene |
| | | (75%) | terephthalate (25%) |
| | Example 51 | Lauric Acid | polyethylene |
| | | (75%) | terephthalate (25%) |
| | Example 52 | Methyl Stearate | polyethylene |
| | | (75%) | terephthalate (25%) |
| Thermal | Example 53 | Cetyl Alcohol | polyethylene |
| Management | | (75%) | terephthalate (25%) |
| (50° C. to | Example 54 | Myristic Acid | polyethylene |
| 150° C.) | | (75%) | terephthalate (25%) |
| | Example 55 | Palmitic Acid | polyethylene |
| | | (75%) | terephthalate (25%) |
| | Example 56 | Stearic Acid | polyethylene |
| | | (75%) | terephthalate (25%) |
| | Example 57 | Behenic Acid | polyethylene |
| | | (75%) | terephthalate (25%) |
| | Example 58 | 12-Hydroxy Stearic | polyethylene |
| | | Acid (75%) | terephthalate (25%) |
| | Example 59 | Trimethylolethane | Polyester (25%) |
| | | (TME) hydrate | |
| | | (75%) | |
| | Example 60 | Adipic Acid | Nylon (25%) |
| | | (75%) | |
| | Example 61 | Boric Acid | Nylon (25%) |
| | | (75%) | |

Various implementations and embodiments of systems, apparatus, and methods have been described in fulfillment of the various objectives of the present disclosure. It should be recognized that these implementations and embodiments are merely illustrative of the principles of the present disclosure. Numerous modifications and adaptations thereof will be readily apparent to those skilled in the art without departing from the spirit and scope of the present disclosure. For example, individual steps of methods described herein can be carried out in any manner and/or in any order not inconsistent with the objectives of the present disclosure, and various configurations or adaptations of apparatus described herein may be used.

1. A composition comprising:
a PCM-containing plasticizer component; and
a scaffold component, wherein a latent heat of fusion of the scaffold component is from 50 J/g to 250 J/g less than a latent heat of fusion of the PCM-containing plasticizer component.

2. The composition of claim 1, wherein the PCM-containing plasticizer component comprises one or more of a fatty acid, a fatty alcohol, an alkyl ester of a fatty acid, a sugar alcohol, an organic acid, a glycol, a biopolymer, and an ionic liquid component.

3-14. (canceled)

15. The composition of claim 1, wherein the scaffold component comprises a phase change material.

16. (canceled)

17. The composition of claim 1, wherein a phase transition temperature of the scaffold component is at least 25° C. higher than a phase transition temperature of the PCM-containing plasticizer component.

18. The composition of claim 1, wherein a latent heat of fusion of the scaffold component is from 100 J/g to 250 J/g less than a latent heat of fusion of the PCM-containing plasticizer component.

19. The composition of claim 1, wherein the scaffold component comprises one or more of a polylactic acid, acrylonitrile butadiene styrene, polyethylene terephthalate, polyethylene terephthalate glycol, thermoplastic polyurethane, a styrenic block copolymer, a polyethylene polymer, a nylon material, and a thermoplastic elastomer.

20-27. (canceled)

28. The composition of claim 1, wherein the PCM-containing plasticizer component and the scaffold component are present in the composition at a ratio by weight percentage of between 10:90 and 90:10.

29-32. (canceled)

33. The composition of claim 1, wherein the PCM-containing plasticizer component has a latent heat of fusion of at least 100 J/g.

34-37. (canceled)

38. The composition of claim 1, further comprising one or more of a thermal conductivity modulator, a nucleating agent, a fire retardant, and an antimicrobial material.

39-41. (canceled)

42. A method comprising:
combining a solid pelletized PCM-containing plasticizer component and a solid pelletized scaffold component in a container to form a solid extrusion mixture, wherein a latent heat of fusion of the scaffold component is from 50 J/g to 250 J/g less than a latent heat of fusion of the PCM-containing plasticizer component;
heating the solid extrusion mixture to a temperature at or above a melting point of both the solid pelletized PCM-containing plasticizer component and the solid pelletized scaffold component to form a pre-extrusion melt mixture;
mixing the pre-extrusion melt mixture; and
extruding the pre-extrusion melt mixture to form an extruded object.

43. The method of claim 42, wherein the PCM-containing plasticizer component comprises one or more of a fatty acid, a fatty alcohol, an alkyl ester of a fatty acid, a sugar alcohol, an organic acid, a glycol, a biopolymer, and an ionic liquid component and wherein a phase transition temperature of the scaffold component is at least 25° C. higher than a phase transition temperature of the PCM-containing plasticizer component.

44-59. (canceled)

60. The method of claim 42, wherein the scaffold component comprises one or more of a polylactic acid, acrylonitrile butadiene styrene, polyethylene terephthalate, polyethylene terephthalate glycol, thermoplastic polyurethane, a styrenic block copolymer, a polyethylene polymer, a nylon material, and a thermoplastic elastomer.

61-68. (canceled)

69. The method of claim 42, wherein the PCM-containing plasticizer component and the scaffold component are present in the composition at a ratio by weight percentage of between 10:90 and 90:10, and wherein the PCM-containing plasticizer component has a latent heat of fusion of at least 100 J/g.

70-78. (canceled)

79. The method of claim 42, wherein the extruded object comprises one or more of a thermal conductivity modulator, a nucleating agent, a fire retardant, and an antimicrobial material.

80-82. (canceled)

83. The method of claim 42, wherein the extruded object is a filament.

84. A method for controlling temperature and/or storing thermal energy, comprising:
providing the composition of claim 1,
wherein the composition of claim 1 is provided in or as part of a vessel,
wherein food, a pharmaceutical, a biological sample, or a vaccine is stored and/or transported in the vessel.

85. (canceled)

86. (canceled)

87. The method of claim 84,
wherein temperature is controlled and/or thermal energy is stored in a range from −90° C. to −60° C., and the PCM-containing plasticizer component comprises ethyl acetate, methyl caproate, methyl linolenate, or mixtures thereof, and the scaffold component comprises styrenic block copolymer.

88. (canceled)

89. The method of claim 84, wherein temperature is controlled and/or thermal energy is stored in a range from −40° C. to −15° C., and the PCM-containing plasticizer component comprises methyl oleate, methyl linoleate, methyl caprylate, or mixtures thereof, and the scaffold component comprises styrenic block copolymer.

90. (canceled)

91. The method of claim 84, wherein temperature is controlled and/or thermal energy is stored in a range from 0° C. to 10° C., and the PCM-containing plasticizer component comprises methyl laurate, propyl myristate, or combinations thereof, and the scaffold component comprises polylactic acid, acrylonitrile butadiene styrene, polyethylene terephthalate, polyethylene terephthalate glycol, thermoplastic polyurethane, styrenic block copolymer, polyethylene polymer, nylon material, thermoplastic elastomer, or combinations thereof.

92. (canceled)

93. The method of claim 84, wherein temperature is controlled and/or thermal energy is stored at a temperature in a range from 2° C. to 8° C., and the PCM-containing plasticizer component comprises methyl laurate, propyl myristate, lauryl alcohol, methyl palmitate, or combinations thereof, and the scaffold component comprises polylactic acid, acrylonitrile butadiene styrene, polyethylene terephthalate, polyethylene terephthalate glycol, thermoplastic polyurethane, styrenic block copolymer, polyethylene polymer, nylon material, thermoplastic elastomer, or combinations thereof.

94-103. (canceled)
